(19) United States
(12) Patent Application Publication
(10) Pub. No.: US 2005/0240762 A1
(43) Pub. Date: Oct. 27, 2005

(54) Cryptographic method and apparatus

(75) Inventor: Wenbo Mao, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/092,413

(22) Filed: Mar. 28, 2005

(30) Foreign Application Priority Data
Apr. 23, 2004 (GB) 0409074.2

(51) Int. Cl. H04L 9/00

(52) U.S. Cl. 713/168

(57) ABSTRACT

A method, apparatus and program are provided by which an entity signs and encrypts an input string using particular instances of a private signature-generation function of a signature trapdoor one-way function pair, and a public encryption function of an encryption trapdoor one-way function pair. As an initial step, the input string is used to form a message string that the entity knows is unique in the context of use by the entity of the particular instances of the signature-generation and encryption functions. Thereafter, a message-recoverable encoding scheme is applied to the message string to form a unique data string that is then subject to the private signature-generation function to produce a signature string. The signature string is in turn subject to the public encryption function to obtain a ciphertext string. Semantic security is achieved without the need to generate a quality random number.

### FIELD OF THE INVENTION

The present invention relates to methods and apparatus for implementing a provably secure cryptographic scheme that combines both signing and encrypting data to obtain private and authenticated communication.

### BACKGROUND OF THE INVENTION

Public-key cryptography is based on the notion of trapdoor one-way function pairs. The “one-way” function part of such a function pair is publicly evaluable while the “trapdoor” function part is evaluable by a key owner solely.

Thus, for a signature trapdoor one-way function pair, there is a private signature-generation function used by a party signing a message, and a public signature-verification function for use by a party wishing to check the authenticity of the message. For an encryption trapdoor one-way function pair, there is a public encryption function used by a party wishing to send an encrypted message to a particular recipient, and a private decryption function for use by that recipient to decrypt the encrypted message. Of course, the functions are generally of a known form but made specific by particular key material.

The public evaluability of the one-way parts of the function pairs is an important property in public-key cryptography because it allows members of public to conduct encryption and signature verification; the former solves the key distribution problem for encryption and the latter enables secure electronic commerce applications.

There apparently exist many quality one-way functions under Shannon's qualification description: “good mixing transformations.” According to Shannon (pages 711-712 of “Communications theory of secrecy systems” Bell Systems Technical Journal, 28:656-715, October 1949), a good mixing transformation can distribute messages in a small and highly redundant region in a message space (the region of data with probability distributions suitable for human comprehension) to fairly uniformly in the entire message space. It is well understood that usual number-theoretic-based one-way functions (such as RSA, discrete logarithm, quadratic residuosity based, etc.) are actually quality mixing transformations. Therefore it is possible to design strong public-key cryptographic systems using these one-way functions, provided great care is taken.

No matter how good a one-way function based mixing transformation can be, the public evaluability of a one-way function enables easy betrayal of message confidentiality and easy forgery of message authorship if security notions are desirably strong. In the case of message confidentiality, a very basic confidentiality notion, semantic security or indistinguishability of plaintext messages, cannot be achieved simply by applying a good one-way function based public-key encryption primitive (let alone further achieving stronger security notions such as indistinguishability against adaptive chosen-ciphertext attack). Here, an adversary, given or chosing plaintext messages, can evaluate the available one-way (encryption) function on the plaintexts and obtain sufficient information to break indistinguishability. In the case of digital signatures, the desirable security notion, (existential) unforgeability of signatures against chosen-message attack, is also difficult to achieve by solely applying a quality one-way function based public-key cryptographic primitive. Here, an adversary can apply the available one-way (signature verification); function to a random value and create an existential forgery (and can then further use the existential forgery to ease a chosen-message attack).

The practical methodology for achieving semantic security (and stronger public-key encryption security properties) for a public-key encryption scheme, and strong unforgeability for a digital signature scheme, is to take a probabilistic approach. This approach involves designing cryptographic schemes which have internal random operations, i.e., using a random input at encryption time or at signing time. With the random input, a resultant ciphertext or signature is a random variable of the random input. Now breaking indistinguishability for the encryption case involves guessing the secret random value r in the input space of the encryption function and the guessing can be very hard if r is sufficiently large. Furthermore, breaking existential unforgeability for the signature case involves making an agreement between the random value r (not necessarily secret in some signature schemes) and the output value of the one-way (signature verification) function and this can also be very hard because of the difficulty of controlling the one-way function in the output end.

The introduction of a random value is also used to provide semantic security and unforgeability for sign-then-encrypt schemes which combine the functionality of a digital signature scheme with that of an encryption scheme. An example of such a sign-then-encrypt scheme is described in the paper “Two Birds One Stone: Signcryption using RSA” by Wenbo Mao and John Malone-Lee, available Dec. 6, 2002 from Hewlett-Packard's website and subsequently available in Topics in Cryptography-Cryptographers Track, RSA Conference 2003, Lecture Notes in Computer Science 2612, pages 210-224, Springer, 2003.

Thus, probabilistic encryption and signature schemes require users to generate secure (i.e., quality) random numbers. However, the generation of quality random numbers is never an easy job for many computing devices which lack good and reliable random sources. This is especially true for low-end devices such as handheld or smartcard-based ones.

### SUMMARY OF THE INVENTION

In general terms, the present invention provides a semantically secure sign-then-encrypt scheme that does not require the use of an internal random operation.

More formally stated, according to the present invention there is provided a method by which an entity signs and encrypts an input string using particular instances of:
a private signature-generation function of a signature trapdoor one-way function pair and
a public encryption function of an encryption trapdoor one-way function pair; the method comprising:
forming a message string m, comprising the input string, in a manner ensuring uniqueness of the message string in respect of use by the entity of said particular instances of the signature-generation and encryption functions;
forming a unique data string p←R(m) where R( )is a message-recoverable encoding scheme;
applying said private signature-generation function S( )to the data string to form a unique signature string S(p); and
applying said public encryption function E( )to the signature string to obtain a ciphertext string c←E(S(p)).

The inventors have found that providing the uniqueness properties set out in the preceding paragraph is provably sufficient to provide semantic security. Such uniqueness properties are generally much easier to achieve than the reliable generation of quality random numbers previously used for securing signcryption schemes such as the one described in the above-mentioned Hewlett-Packard paper.

In one preferred embodiment, the message string m is formed by generating a number in a manner ensuring its uniqueness in respect of use with said particular instances of the signature-generation and encryption functions, and combining it with the content string. For example, the number can be a time measure indicative of a current time or a message count that is incremented each time the method is repeated.

In another preferred embodiment, the content string is a unique content string in respect of use with said particular instances of the signature-generation and encryption functions, the message string being constituted by the content string.

### BRIEF DESCRIPTION OF THE DRAWINGS

Embodiments of the invention will now be described, by way of non-limiting example, with reference to the accompanying diagrammatic drawings, in which:

FIG. 1 is a diagram of two networked computing entities;

FIG. 2 is a diagram illustrating the general form of the sign-then-encrypt scheme embodying the invention;

FIG. 3 sets out the keys used in an RSA-based specific embodiment of the FIG. 2 sign-then-encrypt scheme;

FIG. 4 is a functional block diagram of a message-recoverable encoding scheme of the RSA-based specific embodiment;

FIG. 5 is a flow chart of a ‘sign and encrypt’ phase of the RSA-based specific embodiment; and

FIG. 6 is a flow chart of a ‘decrypt and verify’ phase of the RSA-based specific embodiment.

### BEST MODE OF CARRYING OUT THE INVENTION

In the following description numerous specific details are set forth in order to provide a thorough understanding of the present invention. It will be apparent, however, to one skilled in the art, that the present invention may be practiced without limitation to these specific details. In other instances, well-known methods and structures have not been described in detail so as not to unnecessarily obscure the present invention.

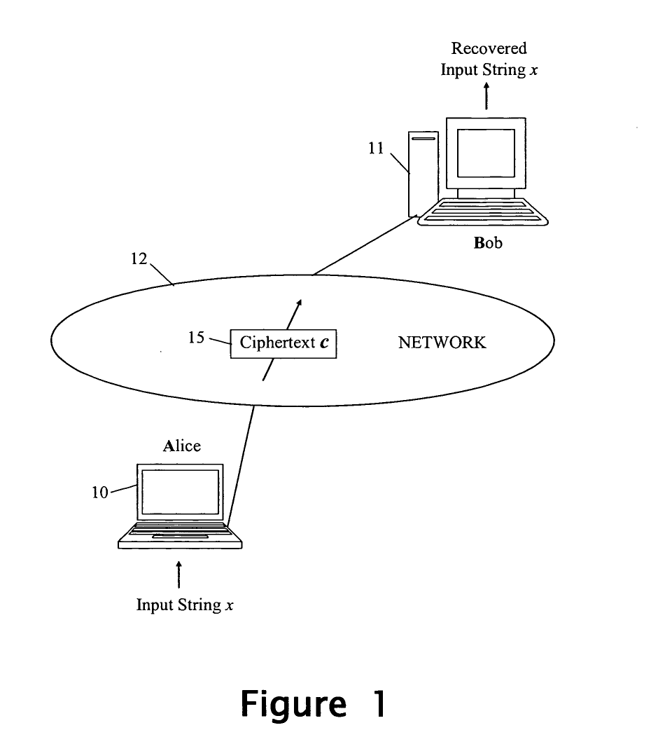

Referring to FIG. 1, there is illustrated schematically two computing entities 10, 11 which can communicate with each other over a communications network 12 in any suitable manner. The first computing entity 10 is hereinafter referred to as entity A or Alice, and the second computing entity 11 is hereinafter referred to as entity B or Bob. By way of example, the entity A can be constituted by a customer device, the network 12 by the public Internet, and the entity B by an electronic commerce server. In other embodiments, the network could be replaced by a direct wired or wireless link between the computing entities.

The computing entities A and B are typically based around programmed general purpose processors arranged to run programs for providing desired functionality such as that required to implement the sign-then-encrypt scheme to be described below. However, additionally or alternatively, one or both entities can be provided with dedicated hardware for implementing all or part of the desired functionality.

As depicted in FIG. 1, using a sign-then-encrypt scheme embodying the present invention, entity A signs and encrypts an input string x to form a ciphertext string c (reference 15) that it then sends over the network 12 to entity B which effects decryption and verification to recover and authenticate the input string x.

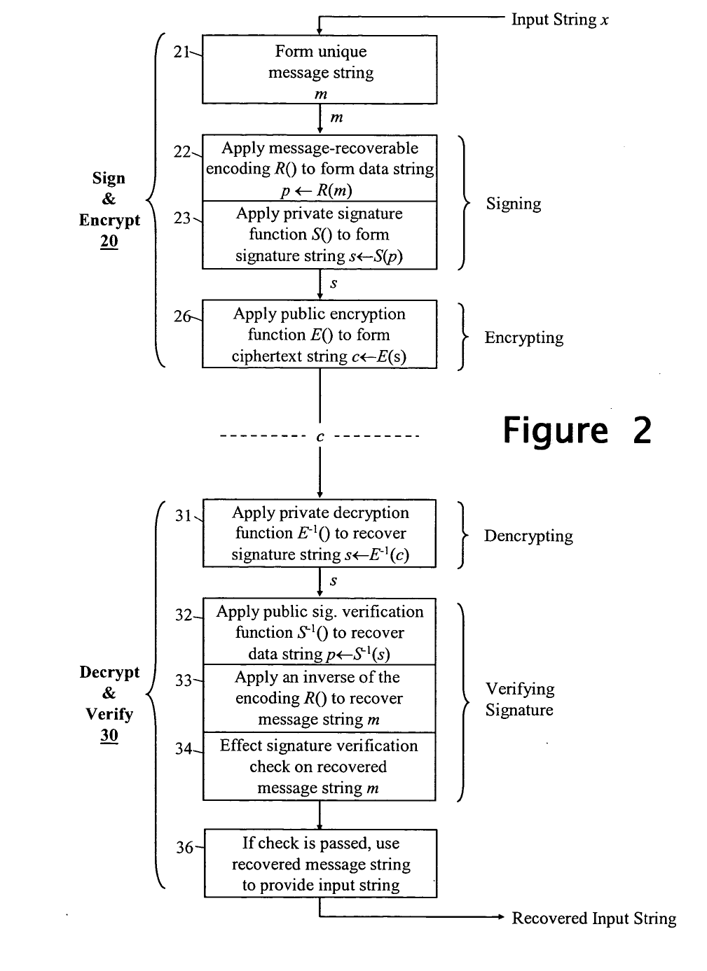

The general form of the sign-then-encrypt scheme used is shown in FIG. 2 and comprises a ‘sign and encrypt’ phase 20 carried out by entity A and a subsequent ‘decrypt and verify’ phase 30 carried out by entity. The sign-then-encrypt scheme uses two trapdoor one-way function pairs, namely:
a signature trapdoor one-way function pair comprising:
   a private signature-generation function S( )used by entity A in phase 20, and
   a public signature-verification function S⁻¹( ) used by entity B in phase 30; and
an encryption trapdoor one-way function pair comprising:
   a public encryption function E( ) used by entity A in phase 20, and
   a private decryption function E⁻¹( ) used by entity B in phase 30.

The trapdoor one-way function pairs are generally of known form, such as RSA-based, but each are particularized for use by specific key material, namely a private key for the private function part and a public key for the public function part. Each private key is held by the entity that is to perform the corresponding private function, this entity usually also disseminating the associated public key. Thus, the entity A holds the private key of the signature trapdoor one-way function pair the public key of which is made available either by entity A or a third party; similarly, the entity B holds the private key of the encryption trapdoor one-way function pair the public key of which is made available either by entity B or a third party. As will be appreciated by persons skilled in the art, when entity B wants to send a secure authenticated message to entity A, the roles of the signature and encryption function pairs can typically be swapped over.

In the ‘sign and encrypt’ phase 20, entity A first uses the input string x to form a unique message string m (block 21). By unique is meant that for the particular instances of the signature and encryption functions being used (as particularized by the key material involved), the current message string m is different from any other message string previously handled by the entity. The entity A is arranged to ensure this uniqueness in any appropriate manner; for example, a sufficiently granular date and time value or a message-string count value can be concatenated with the input string x (or combined in some other reversible manner preserving the uniqueness property), or the input string x itself can be known to be unique (for example, because there is a fixed set of input strings each different from the others and each only usable once—in this case, the string x can be directly used as the message string m).

Once the unique message string m has been formed, it is then signed by the entity A using a signing algorithm that comprises a first part (block 22) in which a message-recoverable encoding R( ) is applied to the message string m to produce a unique data string p, and a second part (block 23) in which the private signature function S( ) is applied to the data string p to produce a signature string s←S(p). The message-recoverable encoding R( ) can, for example, be any suitable padding scheme.

Finally, the entity A encrypts the signature string s (block 26) using the public encryption function E( ) to form ciphertext string c←E(s). Thus c←E(S(p)).

Entity A now sends the ciphertext string c to entity B.

In the ‘decrypt and verify’ phase 20, entity B first decrypts the ciphertext string c by applying the private decryption function E⁻¹( ) to the string c to recover the signature string s←E⁻¹(c).

Next, entity A uses a three-part signature verification algorithm to recover the message string m and verify its authenticity. More particularly, in a first part (block 32) the public signature verification function S⁻¹( ) is applied to the recovered signature string s to recover the unique data string p; in a second part (block 33), an inverse of the encoding R( ) is applied to the recovered string p to recover the message string m; in a third part (block 34), a signature verification check is effected on the recovered message string m to confirm that the message string m comes from a party with access to the private signature function S( ) for which the public signature verification function S⁻¹( ) is the inverse.

Provided the verification check is passed, the recovered message string m is used (block 35) to provide the input string x—if the string x was by its nature unique and therefore directly used as the message string m, block 35 simply outputs the string m, whereas if the string x was combined with a unique value to form m, the string x is separated out from the recovered string m before being output.

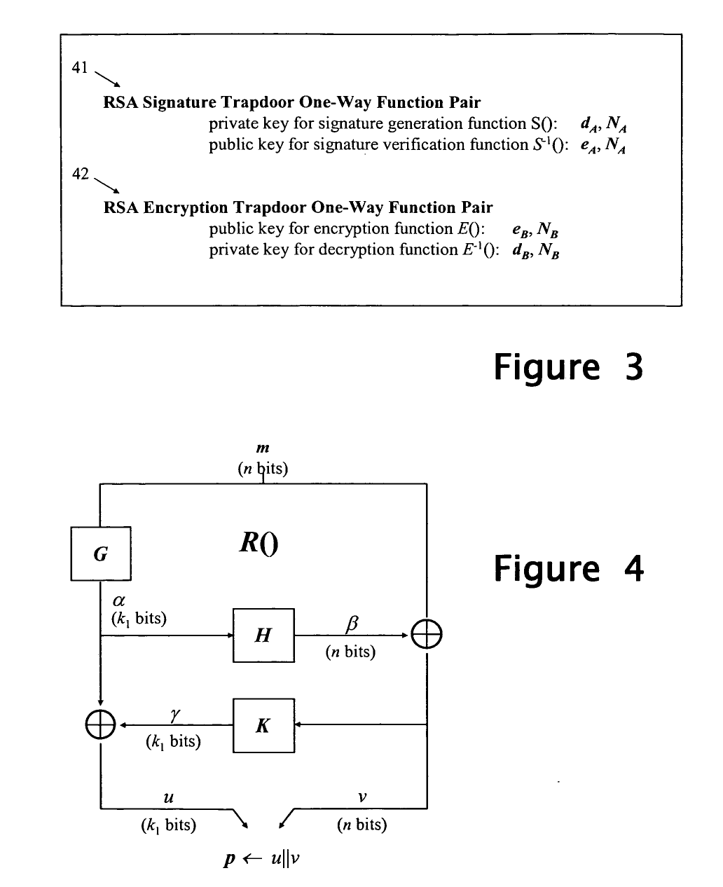

An example RSA-based specific implementation of the FIG. 2 sign-then-encrypt scheme will next be described with respect to FIGS. 3 to 6. More particularly, and as depicted in FIG. 3, both the signature and encryption trapdoor one-way function pairs are RSA-based with public/private key pairs instantiated as follows:
Signature Function Pair 41:
   Private key: (d_{A}, N_{A})—used for signature generation;
   Public key: (e_{A}, N_{A})—used for signature verification;
Encryption Function Pair 42:
   Public key: (e_{B}, N_{B})—used for encryption;
   Private key: (d_{B}, N_{B})—used for decryption

The moduli N_{A} and N_{B} are both k bits in length where k is a system security parameter.

With respect to the message-recoverable encoding scheme R( ), a functional block diagram of the example implementation used here is shown in FIG. 4. This encoding scheme is similar to one proposed by Y. Komano and K. Ohta in the paper “Efficient Universal Padding Techniques for Multiplicative Trapdoor One-Way Permutation” (Advances in Cryptology-CRYPTO 2003,volume 2729 of Lecture Notes in Computer Science, pages 366-382.Springer-Verlag, 2003). The only difference is that in the padding scheme described in the latter paper, the input to the padding scheme is a concatenation of the input string x with a large secret random input r.

Considering the FIG. 4 encoding scheme in more detail, the message string m input to the encoding scheme has a length of n bits and the unique data string p output from the encoding scheme has a length of (k₁+n) bits where k=k₁+n+1. The FIG. 4 encoding scheme uses three hash functions G( ), H( ) and K( ) as follows:
G:{0,1}ⁿ→{0,1}^{k}^{₁}, H:{0,1}^{k}^{₁}→{0,1}ⁿ, K:{0,1}ⁿ→{0,1}^{k}^{₁}

The hash function G( ) is applied to the message string m to form a quantity α of k₁ bits:
α←G(m).

An n-bit quantity β is then formed by applying the hash function H( ) to α:
β←H(α)
after which a further quantity γ of k₁ bits is formed by combining β with m using an Exclusive OR function and then applying the hash function K( ) to the result:
γ←K(m⊕β)
where ⊕ is the Exclusive OR function. Finally, the data string p is formed by concatenating the result u of the Exclusive-OR combination of α and γ, with the result ν of the Exclusive-OR combination of β and m:
p=u∥ν←(α⊕γ)∥(β⊕m)
where ∥ indicates string concatenation.

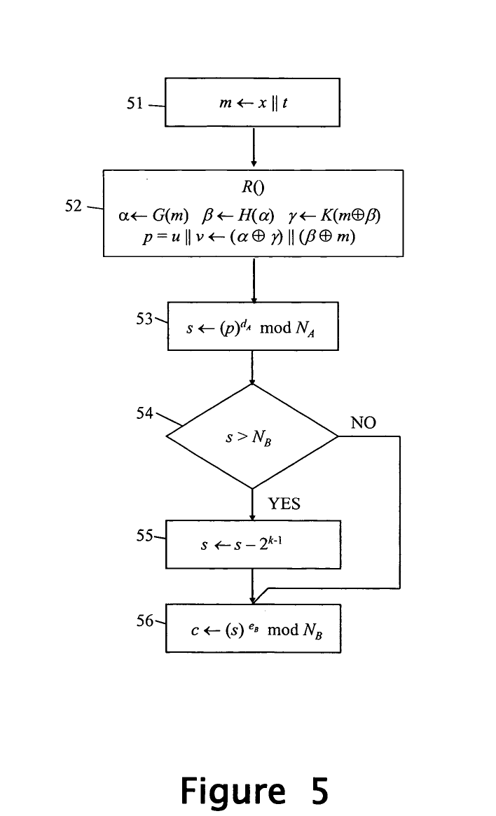

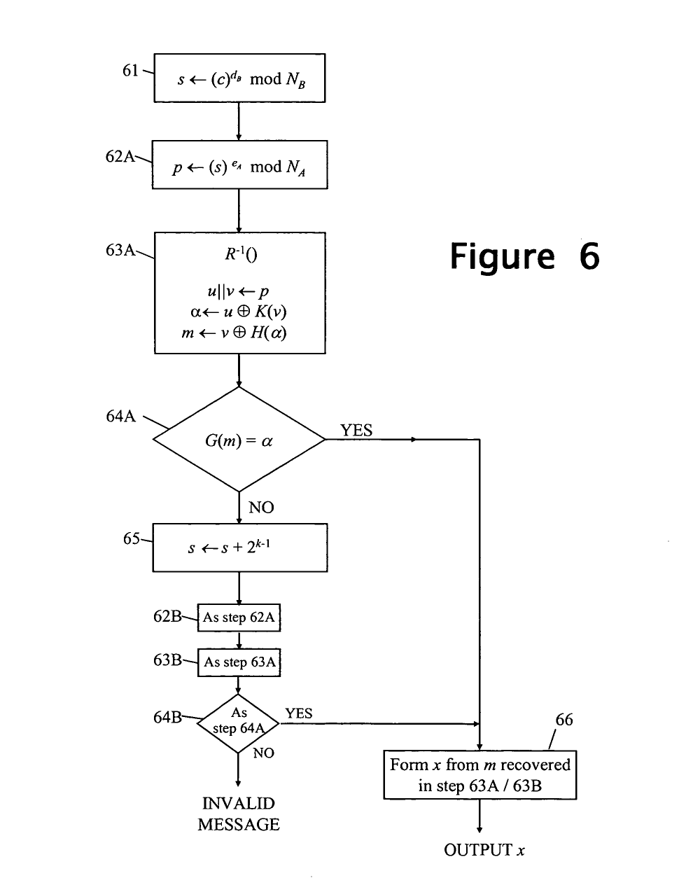

FIG. 5 is a flow chart representing the steps of the ‘sign and encrypt’ phase of the example RSA-based specific implementation of the FIG. 2 sign-then-encrypt scheme. The steps of FIG. 5 that correspond directly to the functional blocks of FIG. 2 have been given the same reference increased by thirty—thus the initial step 51 of FIG. 5 corresponds to block 21 of FIG. 2 in which the input string x is used to produce a unique message string m; in the FIG. 5 example this is done by concatenating the input string x with a unique time value t. Next, step 52 (corresponding to block 22 of FIG. 2) is effected to apply the FIG. 4 encoding scheme to the message string p, the result being a (k−1)-bit unique data string p.

In step 53 (corresponding to block 23 of FIG. 2), the signature-generation function S( ) is applied to the string p to provide the signature string s:
s←(p)^{d}^{_{A}} mod N_{A}

Because the output space of the signature function S( ) and the input space of E( ) are both the numbers up to k bits, it is significantly probable that a number output from S( ) is greater than that which E( ) can take as input. This is tested for in step 54 and if s is found to be greater than N_{B}, the most significant bit (msb) of s is simply removed (step 55), it being noted that this msb must necessarily be 1 for the situation to have arisen. During the ‘decryption and verification’ phase, a trial and error process can be used to determine whether a msb of value 1 needs to be added back to the recovered value of s. The un-truncated or truncated value of s is then encrypted in step 56 (corresponding to block 26 of FIG. 2) by applying the encryption function E( ) to the presented value of s to produce the ciphertext string c:
c←(S)^{e}^{_{B}} mod N_{B}

FIG. 6 is a flow chart representing the steps of the ‘decrypt and verify’ phase of the example RSA-based specific implementation of the FIG. 2 sign-then-encrypt scheme. The steps of FIG. 6 that correspond directly to the functional blocks of FIG. 2 have been given the same reference increased by thirty. The first step 61 (corresponding to block 31 of FIG. 2) involves applying the decryption function E⁻¹( ) to the received ciphertext string c to recover the signature string s:
s←(c)^{d}^{_{B}} mod N_{B}

Next, message recovery and signature verification are carried in steps 62A, 63A and 64A (corresponding to a first iteration of the blocks 32-34 of FIG. 2). More particularly, in step 62A the signature-verification function S⁻¹() is applied to the recovered value of s (assumed not to have been truncated) in order to recover the data string p:
p←(s)^{e}^{_{A}} mod N_{A}

In step 63A an inverse of the FIG. 4 message-recoverable encoding function R( ) is used to recover the message string m. This involves separating out values of u and ν from the recovered data string p and then recovering the quantity α as:
α←u⊕K(ν);
the message string m is then recovered as:
m←ν⊕H(α).

In step 64A a verification check is carried out by checking whether:
G(m)=α

If this check is passed, the recovered message string m is used in step 66 (corresponding to block 36 of FIG. 2) to produce the original input string x. However, if the check fails, it may simply be because the recovered value of s needs to have a msb of 1 added to compensate for the removal of this msb in step 55 of the ‘sign and encrypt’ phase. Therefore, failure of the check carried out in step 64A results in the addition of a msb of 1 to the value of s in step 65. Thereafter the three signature verification steps are repeated as steps 62B, 63B and 64B. If the check carried out in step 64B is failed, then an “invalid message” output is produced, otherwise the value of m recovered in step 63B is supplied to step 66 to provide the original string x.

For signature, the above-described sign-then-encrypt implementation has unforgeability against adaptive chosen-message attack (ACMA) and for encryption it has indistinguishability against adaptive chosen-ciphertext attack (IND-CCA2).

It will be appreciated that many variants are possible to the above described embodiments of the invention. For example, the manner in which a mis-match between the output of the signature function and the input of the encryption function is handled in the example RSA-based specific embodiment, is an implementation detail and other ways of handling this mis-match can be employed (such as by repeating steps 51 to 53 with modified, but still unique, values of t until a mismatch is avoided) or else implementations can be used that do not present this potential for a mis-match.

The signature and encryption trapdoor one-way function pairs S( ), S⁻¹( ) and E( ), E⁻¹( ) can be implemented by public-key cryptographic schemes other than RSA such as the Rabin public-key cryptographic scheme. Furthermore, different message-recoverable encoding schemes R( ) such as the PSS padding scheme used in the above-referenced Hewlett-Packard paper (that padding scheme that was originally designed to create a provably secure signature algorithm when used with RSA—see “The Exact Security of Digital Signatures—How to sign with RSA and Rabin” M. Bellare and P. Rogaway, in Advances in Cryptography—EUROCRYPT '96, volume 1070 of Lecture Notes in Computer Science, pages 3399-416, Springer-Verlag, 1996).

The Annex that forms the following pages of this description set out a proof of the semantic security and unforeability of the above-described embodiments of the present invention. The terminology and symbols used in the Annex differ in some respects from those used elsewhere in this specification and are to be understood in the context of the Annex taken alone.

1. A method by which an entity signs and encrypts an input string using particular instances of:
a private signature-generation function of a signature trapdoor one-way function pair and
a public encryption function of an encryption trapdoor one-way function pair;
the method comprising:
forming a message string m, comprising the input string, in a manner ensuring uniqueness of the message string in respect of use by the entity of said particular instances of the signature-generation and encryption functions;
forming a unique data string p←R(m) where R( ) is a message-recoverable encoding scheme;
applying said private signature-generation function S( ) to the data string to form a unique signature string S(p); and
applying said public encryption function E( ) to the signature string to obtain a ciphertext string c←E(S(p)).

2. A method according to claim 1, wherein the message string m is formed by generating a number in a manner ensuring its uniqueness in respect of use with said particular instances of the signature-generation and encryption functions, and combining it with the input string.

3. A method according to claim 2, wherein the number is a time measure indicative of a current time.

4. A method according to claim 2, wherein the number is a message count that is incremented each time the method is repeated.

5. A method according to claim 1, wherein the input string is a unique content string in respect of use with said particular instances of the signature-generation and encryption functions, the message string being constituted by the input string.

6. A method according to claim 1, wherein the message string m has a length of n bits and the unique data string p has a length of (k₁+n) bits, the message-recoverable encoding scheme R( ) forming the data string p as:
p=u∥ν←(α⊕γ)∥(β⊕m)
where:
⊕ is the Exclusive OR function and ∥ indicates string concatenation,
α←G(m); β←H(α); γ←K(m⊕β), and
G( ), H( ) and K( ) are hash functions:
G:{0,1}ⁿ→{0,1}^{k}^{₁}, H:{0,1}^{k}^{₁}→{0,1}ⁿ, K:{0,1}ⁿ→{0,1}^{k}^{₁}

7. A method according to claim 1, wherein the trapdoor one-way function pairs are RSA function pairs.

8. A method according to claim 1, wherein the trapdoor one-way function pairs are Rabin function pairs.

9. Apparatus for signing and encrypting an input string using particular instances of:
a private signature-generation function of a signature trapdoor one-way function pair and
a public encryption function of an encryption trapdoor one-way function pair; the apparatus comprising:
a message-forming arrangement for receiving said input string and forming a message string m comprising the input string, in a manner ensuring uniqueness of the message string in respect of use by the apparatus of said particular instances of the signature-generation and encryption functions;
an encoding arrangement for forming a unique data string p←R(m) where R( ) is a message-recoverable encoding scheme applied to the message sting m;
a signing arrangement for applying said private signature-generation function S( ) to said data string to form a unique signature string S(p); and
an encryption arrangement for applying said public encryption function E( ) to the signature string to obtain a ciphertext string c←E(S(p)).

10. Apparatus according to claim 9, wherein the message-forming arrangement is arranged to form said message string m by generating a number in a manner ensuring its uniqueness in respect of use with said particular instances of the signature-generation and encryption functions, and combining it with the input string.

11. Apparatus according to claim 10, wherein said message-forming arrangement is arranged to keep a time measure indicative of a current time, and to use this time measure as said number.

12. Apparatus according to claim 10, wherein said number is a message count that said message-forming arrangement is arranged to increment each time the method is repeated.

13. Apparatus according to claim 9, wherein the encoding arrangement is arranged to form said data string p as:
p=u∥ν←(α⊕γ)∥(β⊕m)
where:
⊕ is the Exclusive OR function and ∥ indicates string concatenation,
α←G(m); β←H(α); γ←K(m⊕β), and
G( ), H( ) and K( ) are hash functions:
G:{0,1}ⁿ→{0,1}^{k}^{₁}, H: {0,1}^{k}^{₁}→{0,1}ⁿ, K:{0,1}ⁿ→{0,1}^{k}^{₁}
where: n is the length in bits of the message string m, and
(k₁+n) is the length in bits of said data string p.

14. Apparatus according to claim 9, wherein the trapdoor one-way function pairs are RSA function pairs.

15. Apparatus according to claim 9, wherein the trapdoor one-way function pairs are Rabin function pairs.

16. A computer-readable medium storing a computer program arranged to condition a program-controlled computer, when executed by the latter, to sign and encrypt an input string using particular instances of:
a private signature-generation function of a signature trapdoor one-way function pair and
a public encryption function of an encryption trapdoor one-way function pair; the signing and encrypting of said input string comprising:
forming a message string m, comprising the input string, in a manner ensuring uniqueness of the message string in respect of use by the entity of said particular instances of the signature-generation and encryption functions;
forming a unique data string p←R(m) where R( ) is a message-recoverable encoding scheme;
applying said private signature-generation function S( ) to the data string to form a unique signature string S(p); and
applying said public encryption function E( ) to the signature string to obtain a ciphertext string c←E(S(p)).
